(19) United States
(12) Patent Application Publication
(10) Pub. No.: US 2005/0203784 A1
(43) Pub. Date: Sep. 15, 2005

(54) Services component business operation method

(75) Inventor: Guy J. Rackham, New York, NY (US)

Correspondence Address: John R. Pivnichny;IBM Corporation, Dept IQ0A, Bldg. 40-3, 1701 North Street, Endicott, NY, 13760, US

(73) Assignee: INTERNATIONAL BUSINESS MACHINES CORPORATION, ARMONK, NY (US)

(21) Appl. No.: 10/796,367

(22) Filed: Mar. 9, 2004

(51) Int. Cl. G06F 17/60

(52) U.S. Cl. 705/7

(57) ABSTRACT

A method of providing business process services to a client company involves building a map of components of activities. The components are groups of cohesive business activities supported by appropriate processes, applications, infrastructure, and metrics. Components are filtered by cost, revenue, and competitive levels forming a heat map. Attributes are applied to activities in the components and a solution stack framework for the state vision of the client company is built. Quick hits and investment opportunity projects are developed from the solution stack and prioritized forming a roadmap of tasks for implementation at the client company.

### TECHNICAL FIELD

The invention relates generally to business methods for defining and implementing enhancements to the operation of a business. More particularly the invention relates to methods for developing proposals which may be rapidly implemented having rapid payback, and for developing investment opportunities.

### BACKGROUND OF THE INVENTION

Providing information technology services to companies and other organizations has become a huge business opportunity for the providers. A company or other organization may reduce operating expenses by contracting with a service provider to take over certain existing in-house provided operational services. This process is often called “outsourcing” or “business transformation outsourcing.” Such services may be in the areas of finance, procurement, administration, human resources, benefits, payroll, or any other business area including customer relationship management.

A services provider having many client companies may often be able to provide such services to each individual client at a lower cost than the client itself due to economies of scale and use of best practices at all clients. Costs of upgrading may also be reduced, while also improving the quality and uniformity of upgrades. Cost reductions may be so dramatic that not only does the client benefit, but the provider also enjoys a substantial profit margin.

Various methods have been developed for providing such services. Barrett et al. in US Patent Application Publication U.S. 2002/0194053A1 describe a system for providing integrated solutions using engagement templates. Hashimoto et al. in U.S. Pat. No. 5,745,878 describe apparatus for handling business requirements and a method for processing a business transaction. Barrett and Hashimoto shall be incorporated herein by reference.

Large profit margins inevitably attract additional providers, increasing competition for client business, reducing overall profit margins. It is therefore in the best interest of the provider to develop improved methods for delivering services at even lower costs in order to increase profits and/or win market share away from competitors. The present invention constitutes such an improvement. It is believed that this represents a significant advancement in the services providing arts.

### OBJECTS AND SUMMARY OF THE INVENTION

It is therefore a principal object of the present invention to enhance the services providing arts by making available a method of operating a business with enhanced capabilities.

It is another object to make available a method of developing a business roadmap for a client.

It is a further object to make available such enhanced methods embodied as a program storage device having instructions executable by a machine.

It is yet another object to make available methods for deploying, accessing, and integrating such enhanced methods for operating a business for a client.

These and other objects are attained in accordance with one embodiment of the invention wherein there is provided a method of operating a business, comprising the steps of building a map of components of activities, filtering the map of components to form a heat map of selected components, defining attributes for the selected components, based on a competency lens, identifying collaborations for the selected components, building a business component solution stack using the heat map, the attributes, and the collaborations, developing quick hits and investment opportunities from the solution stack, defining a road map of tasks for implementing the quick hits and investment opportunities, and implementing the roadmap for the business.

In accordance with another embodiment of the invention there is provide a method of developing a business roadmap for a client, comprising the steps of building a map of client components of activities, filtering the map of components to form a heat map of selected components, defining attributes for the selected components, based on a client competency lens, identifying collaborations for the selected components, building a business component solution stack using the heat map, the attributes, and the collaborations, developing quick hits and investment opportunities from the solution stack, and defining a client business roadmap of tasks for implementing the quick hits and investment opportunities.

In accordance with yet another embodiment of the invention there is provided a program storage device readable by a machine, tangibly embodying a program of instructions executable by the machine to perform method steps for operating a business, the method steps comprising building a map of components of activities, filtering the map of components to form a heat map of selected components, defining attributes for the selected components, based on a competency lens, identifying collaborations for the selected components, building a business component solution stack using the heat map, the attributes, an the collaborations, developing quick hits and investment opportunities for the solution stack, defining a roadmap of tasks for implementing the quick hits and investment opportunities, and implementing the roadmap for the business.

### BRIEF DESCRIPTION OF THE DRAWINGS

FIG. 1 is a flowchart illustrating the various steps involved in carrying out one embodiment of the present invention;

FIG. 2 illustrates a map of components;

FIG. 3 shows the process of allocating revenue;

FIG. 4 illustrates consolidator/server collaborations;

FIG. 5 illustrates processor collaborations; and

FIG. 6 illustrates gatekeeper collaborations.

### BEST MODE FOR CARRYING OUT THE INVENTION

For a better understanding of the present invention together with other and further objects, advantages, and capabilities thereof, reference is made to the following disclosure and the appended claims in connection with the above-described drawings.

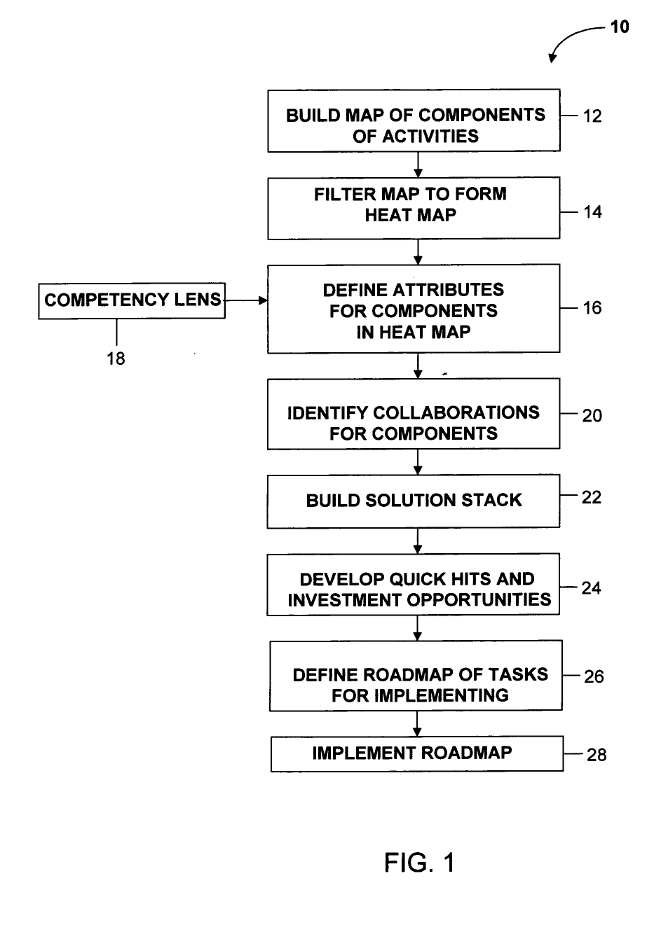

In FIG. 1 there is shown flowchart 10 depicting steps of a process for carrying out an embodiment of the present invention. In step 12 a map of components of activities is built. For a particular client business a component shall be taken to mean a group of cohesive business activities supported by appropriate processes, applications, infrastructure, and metrics. Applications may be software applications supporting a business activity. Each component is flexible. Components may work in any combination or sequence with other components to get the job done. Each component may be individually scalable and extensible.

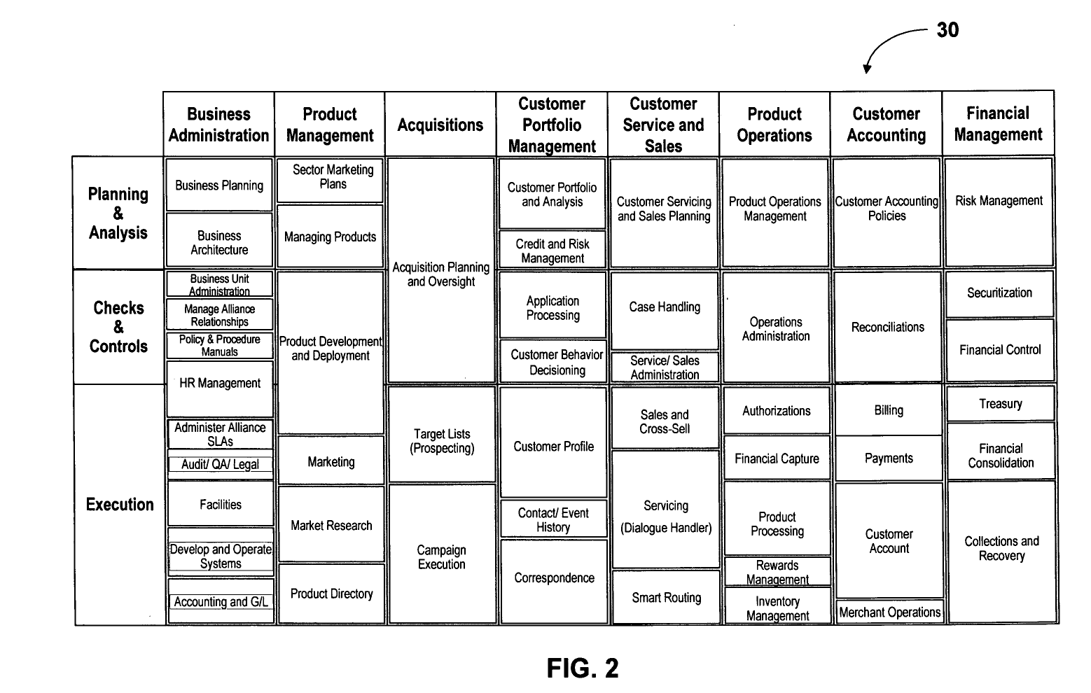

FIG. 2 shows an example of such a map of components. The rows of matrix 30 are grouped into three management levels of business activities, namely, planning and analysis, checks and controls, and execution. The rows of the matrix are standard for all industries, defining three levels of management control. For each grouping of activities in a column, a combination of these three levels is required to ensure the business operates effectively.

The columns of matrix 30 are activity categories which will be industry specific. However, once a good component map is built for any client, it may be used for any other client or competency in that specific industry. Business activities are determined in interviews supported by subject area specialists to identify both current and future capabilities. Activities may be specified in the following general terms:
Functionality—the Subject
Users—Skill level, authority
Systems
   Analytical
   Operational Decisioning
   Automated
Operational Characteristics
Business Information Usage
   or any other general terms used in the industry.

Components within the activity categories should be able to be extracted (e.g., outsourced) without disrupting the enterprise. Smart components may be defined and represent opportunities for development by the services providing company. A component map, when built, depicts the future enterprise and industry leading practices. The level of detail is appropriate for the required analysis (is retractable and expandable). Activities are performed only in one component.

The column titles in FIG. 2 represent an example of activity categories for a specific industry. Activity categories for a client company in another industry such as the insurance industry may be those shown below in Table 1.

TABLE 1
Activity Categories for Insurance
Company Client

Product Development
Risk Management
Marketing
Business Acquisition and Retention
New Business Installation and Enrollment
Services
Claims
Business Administration and Finance

In step 14 of FIG. 1 the component map built in step 12 is filtered to form a heat map. For each activity category in component map 30, capabilities are defined that summarize how the organization seeks to perform in that aspect of its business. Target competitive levels are then determined for each capability. For example, levels of base, competitive, or differentiated may be used. The competitive levels are then translated onto component map 30, e.g. color coding or shading of components in map 30 may be used to indicate the level.

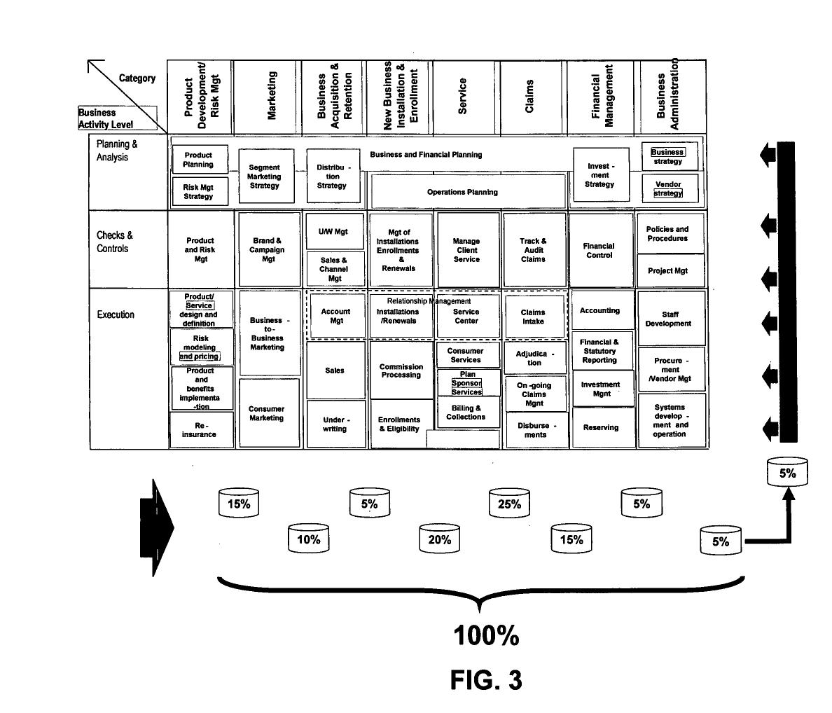

Cost filtering as shown in FIG. 3 may also be performed in step 14. For example, a cost pie of 100% may be allocated to the activity categories (columns). In FIG. 3 15% of cost is allocated to Product Development/Risk Management. The allocation may be based on cost center data. Any other basis of allocating cost may be used such as by the number of full time equivalent (FTE) people required to perform the activities involved. For each column, the allocated cost is then distributed across components in that column on another basis, for example, headcount. In FIG. 3 the 5% allocated to Business Administration is distributed across the components in the last column by headcount.

Revenue filtering may be performed using similar allocation and distribution methods.

Cost and revenue filtering may also be depicted by dollar value sorting into high, medium, and low buckets, e.g.:

| | |
|---|---|
| low | <$10M |
| medium | $10M to $70M |
| high | >$70M |

The results of cost and/or revenue filtering are also summarized on the component map such as by indicating the cost and/or revenue levels or bucket for each component.

After applying the filtering just described, components are selected to form a heat map. Selected components should be components that drive the primary strategy of the company such as low cost provider, brand, servicing, and have a large gap between the current and desired capabilities. Components that have a large potential to increase revenue or reduce cost may also be selected. Components that the client or interviews have identified as problematic may be selected. Components required to perform key functions may also be selected.

A component map having only the selected components shall be designated herein to be a heat map.

In step 16 attributes are defined for the selected components in the heat map. Attributes may be defined based on a competency lens provided in step 18. Attributes to analyze a component are based in the general service area and the specific project offering. The key functions of a component are attributed based on the current and desired industry maturity level. On-demand attributes are used when the intent of the analysis is migrating the client company toward an on-demand solution. This defining attributes step may need to be applied iteratively or repeated.

The competency lens provided in step 18 includes competency offerings such as business strategy, information technology (IT) strategy, organizational strategy, and operations strategy. For example, use of the organizational strategy competency offering in the competency lens to analyze or evaluate based on a criteria, a selected component in the heat map, may lead to defining “skills” or “roles” as an attribute for that selected component. Attributes of “processes” or “consumption” may be associated with use of the operations strategy competency offering in the competency lens of step 18. The component is then assessed based on the defined attributes and any gaps or shortfalls are noted.

In step 20 collaborations for components are identified. Patterns may be applied to candidate components. These patterns are used to model how the components might collaborate dynamically to support key business processes such as launching a product, acquiring a new customer, or detecting and responding to fraud. The patterns can be matched to the behaviors of components to identify structural process improvement opportunities as well as on-demand opportunities. Examples of patterns are listed below in table 2.

TABLE 2
Collaborative Patterns

| | |
|---|---|
| Consolidator/Server | A goto point for a frequently/widely |
| | referenced function or information |
| Processor | A discrete step in a process (bounded |
| | for re-use in multiple processes) |
| Gatekeeper | Coordinating access to multiple |
| | services (to fully exploit/parallelize |
| | an event) |
| Controller | Overseeing, trouble shooting, |
| | authorizing and/or classifying/checking |
| Analyzer | Gathering management information - |
| | planning, targets, sensitivity |
| | assessment rating. |

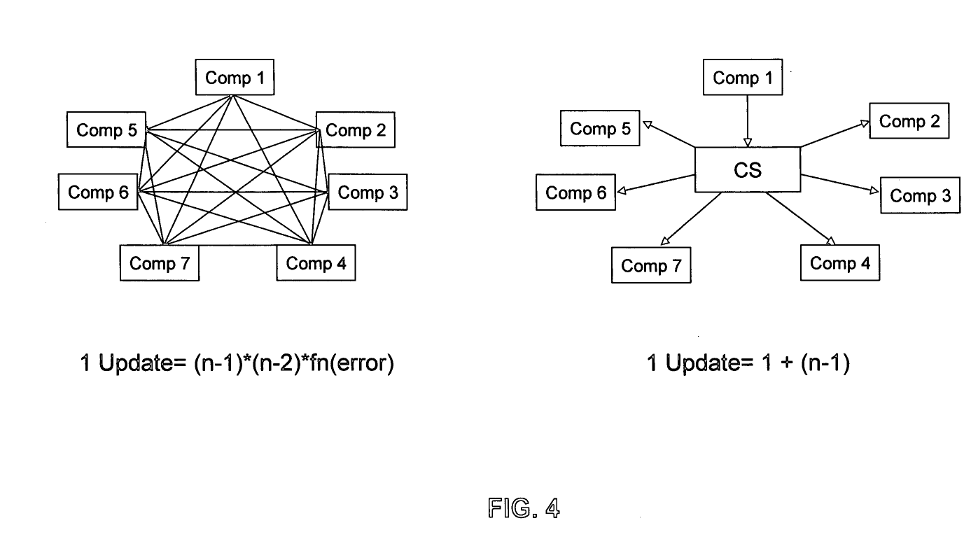

By way of example, a consolidator/server collaboration will now be explained with reference to FIG. 4. The components for a consolidator/server collaboration provide a single goto point for widely referenced information and/or services. The role of the component is to reduce the number of connections needed to reference and maintain information and thereby improve the simplicity and consistency of business activity. When information is maintained independently in many locations, there is increased potential for error and a need for significant connectivity to ensure changes are coordinated.

FIG. 4 shows before and after implementing an identified consolidator/server collaboration. In the before diagrams on the left, similar information and services are developed where they are needed, and peer connectivity is used to coordinate changes. Because there are (n−1)*(n−2) connections, where n is the number of components, an update may result in a large chance of error even if the chance of error on an individual connection, fn(error), is small.

On the right in FIG. 4, after implementing collaboration, all components reference a specialist component, using common services to reference and/or update the information. Components may maintain local copies of information for performance purposes with a number of known protocols used to update/reference the specialist component such as access when required, broadcast changes, and periodic update of local copies.

Consolidator/servers may be developed from a legacy application or more typically are supported by new purpose built systems. Referencing components can retain their local data structure to limit internal change, but local maintenance logic is removed and replaced by service access routines that reference the specialist component. These may include local encapsulation/wrappers for isolated conversion.

The impact to the client business will be reduced complexity—multiple links between peer components are eliminated, improved responsiveness—changes in one area are captured centrally and relayed to other subscribing components, improved quality/error reduction—central governance eliminates double updates and inconsistency, and enhanced capabilities—the single specialist service supports focused incremental development of enhancements.

A processor collaborative pattern involves processor components which are specialized processing facilities. A processor component includes only the specific functionality needed to fulfill its role with all other required services provided through collaborations with other components. A processor component also has a supply/subscribe service interface so that it can be invoked from any other component as appropriate.

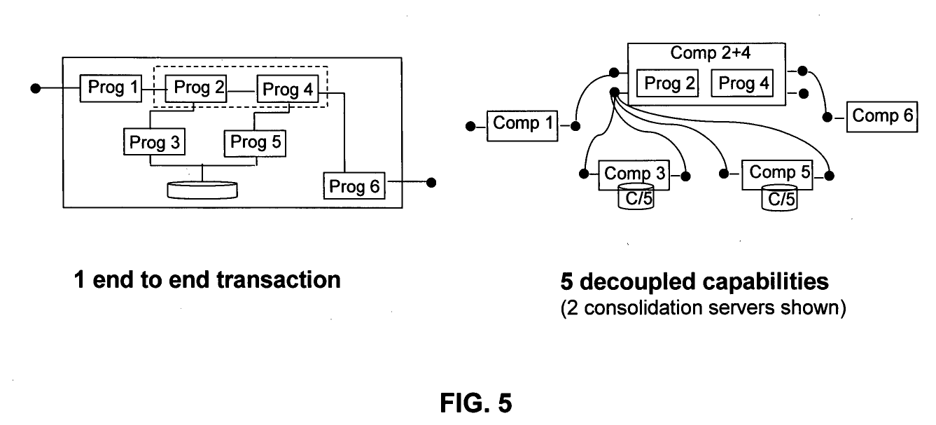

As seen in FIG. 5 on the left, before processor collaboration is identified and applied, processing is performed by a monolithic processor that contains all associated services. However, a rigid workflow is imposed with this structure. After application of processor collaboration as seen in FIG. 5 right, processing is streamlined, tasks are generalized and decoupled, leaving generic specialized services.

Processor components reduce processing to a streamlined minimum, referencing consolidator/server components for common information and service. Processor components may link with other processor components, optionally through the oversight of gatekeeper components (described below) to execute a business transaction. By developing processing into generalized tasks where possible, re-use is maximized. By service enabling processing, flexibility is maximized as components can be wired together in any working sequence or combination.

Processor components will frequently be re-purposed legacy applications. Re-purposing will be a combination of breaking the legacy application into component aligned modules, wrapping these modules in a supply/subscribe service interface, and extracting and remotely referencing any functionality that is better supported by a consolidator/server component. The business impact of identifying and implementing processors collaborations is reduced complexity/improved performance—component is reduced to its optimized processing minimum, improved re-use−the component provides generalized service, and improved flexibility—component services are enabled.

Gatekeeper collaboration involves use of gatekeeper components which oversee access to other components for complex business transactions where different situations require different responses. The gatekeeper component seeks to ensure that all necessary tasks and all possible opportunities to leverage an event are exercised in an optimized combination or sequence.

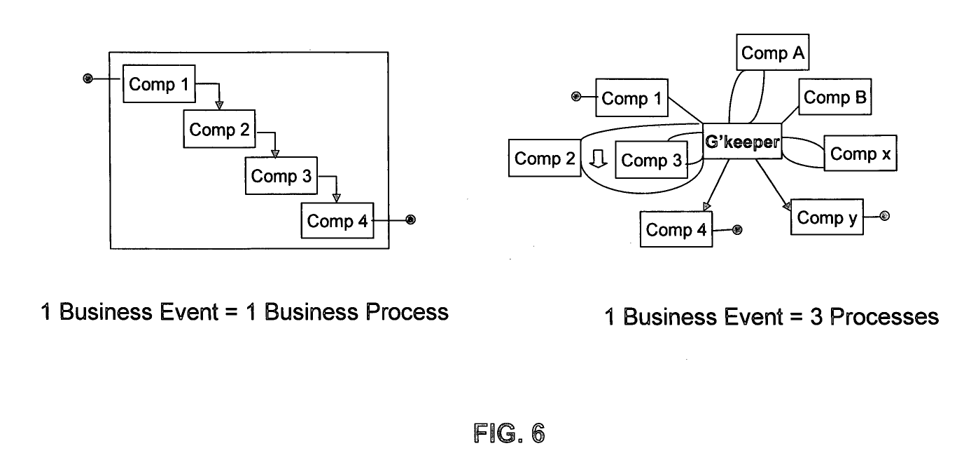

Before identification of gatekeeper collaboration, business events are processed following a pre-defined approach as seen in the left side of FIG. 6. Optional tasks are not always identified and exploited. As depicted in FIG. 6 right, after gatekeeper collaboration is applied, business events are “gang tackled”, leveraging all facilities and exercising all applicable tasks viewed across the client enterprise.

Gatekeeper components are triggered by an event, such as a customer contact, and follow decisioning logic to invoke as many activities in parallel and in an optimized sequence to respond. In addition, the gatekeeper component will determine whether the event presents an opportunity to launch other responses, such as cross sell, or process pending tasks, such as deliver e-mail.

Gatekeeper components will typically be purpose built, but may include consolidated decisioning logic from legacy systems. Their development needs to be incremental as new services are enabled with the development of consolidator/server and processor components.

The business impact of identifying and implementing gatekeeper collaborations is improved exploitation—each business event is fully leveraged to invoke all applicable components and pending processes, improved responsiveness—business rules can be streamlined and optimized to provide optimal response, and improved flexibility—tasks can be decoupled/executed in parallel/sequenced in an event/state driven manner.

Controller collaboration involves use of controller components which oversee the execution of business. They perform checks, classification or qualification activity, handle exceptions, and detect and resolve issues arising in execution. Controller components will typically support oversight/line management functions and will leverage information and technology to support operational decisioning.

Before identifying and implementing controller collaboration, checks and exceptions requiring specialist or senior staff involvement are tightly bound into execution, or poorly supported. Afterwards, checks and exceptions are isolated from execution and routed to specialist/senior resources for resolution using suitable facilities.

Controller components monitor execution activities and can be triggered by business events and exceptions. Checks may be required at certain times, due to certain situations or when thresholds are breached. Typically a controller component will execute independently (asynchronously) of execution tasks, taking pending actions off, and returning results to work queues. Where controller components support complex decisions, they may invoke other controller components in resolving an issue.

Controller components will typically be purpose built but may consolidate decisioning logic from legacy systems. Their development needs to be incremental as new services are enabled with the development of consolidator/server and processor components. Decisioning logic may be migrated from legacy applications as they are re-purposed. Controller components provide a point of focus for future incremental development, supporting ever more sophisticated decisioning capabilities.

The business impact of identifying and implementing controller collaboration is improved productivity —decoupling of checks and controls from execution streamlines production, improved specialist resource leverage—issues are directed to facilities and individuals best qualified to answer them, and improved flexibility—incremental development and collaborations between controller components are highly flexible and scalable.

Analyzer collaborations involve use of analyzer components which support top level decision making. These components present consolidated and historical business information, optionally supported by externally generated market information to support policy making and business direction. Analyzer components can support scenario development, sensitivity analysis planning, and consolidated business performance tracking.

Before analyzer collaboration is identified and implemented, senior management decisioning at the client company is constrained by the quality and timeliness of business information and the existing supporting analysis tools. After analyzer collaboration is implemented, key activity information is extracted and consolidated from control and execution components in standard formats with full analysis facilities.

Analyzer components absorb summary business activity details over time. Standard message formats, extract schedules and mechanisms automate the extract process ensuring consistent information is used to direct the overall business activity. Return reporting to the business from analyzer components can be supported to communicate policies, budgets, goals, or priorities. However, the benefit of automating such flows are less significant.

Analyzer components will typically be purpose built but may consolidate existing reporting and analysis logic from legacy systems. Their development needs to be incremental as new activity information becomes available with the development of controller, processor, gatekeeper, and consolidator/server components.

The business impact of identifying and implementing controller collaboration is improved business decisions—improved quality and timeliness of business activity information supports better decisions, and improved responsiveness—a tighter feedback loop from top level management supports more interactive policy development/business direction.

Returning now to FIG. 1, in step 22 a business component solution stack is built using the heat map, the defined attributes, and the identified collaborations. The attributes and collaborations are layered onto the components in the two dimensional heat map forming a three dimensional stack of potential solutions. The solution stack represents a framework for the desired future state vision of the client company.

Revenue levers may be applied to the component attributes by determining how fast revenue is impacted by the component. Examples of revenue levers are market penetration, franchise penetration, share of wallet, customer retention, profit margin, profit fees, profit processing overhead, and avoidable losses.

Cost levers may also be applied. Examples of cost levers include new customer acquisition, staff turnover, productivity, time to money, and asset optimization. These are determined as a dollar value per year.

The revenue and cost lever values are applied to the components and may be used in building the solution stack in step 22.

In step 24 quick hits and investment opportunities are developed from the solution stack. An assessment is performed for each attribute to determine shortfalls or gaps as compared to best industry practice. Current and desired future capacities are defined for base, competitive, and differentiated levels. A functionality analysis is performed for each component and the services it references and offers to other components.

From these analyses of the solution stack framework projects having a short development cycle and rapid benefit known as quick hits are developed. Longer term projects with significant payback known as investment opportunities are also developed. On a listing of quick hits and investment opportunities, each project may be categorized. For example, categories may be an application enhancement (AE), new application—green field (GF), application reduction (AR) and business process only (BP).

In step 26 a roadmap of tasks for implementing each project is defined. For each project, a project template may be used to fully document the critical aspects of the project. For example, the template may include project description, a high level cost/benefit analysis, risks, approach, work effort estimate, dependencies, and outputs.

In step 28 the projects are prioritized relative to each other based on the entries in the templates, creating a portfolio of opportunity. Projects designated as quick hits define the first wave of implementation. Further waves of projects are selected from the prioritized opportunity portfolio and implement in step 28.

While there have been shown and described what are at present considered the preferred embodiments of the invention, it will be obvious to those skilled in the art that various changes and modification may be made therein without departing from the scope of the invention as defined by the appended claims.

1. A method of operating a business, comprising the steps of:
building a map of components of activities;
filtering said map of components to form a heat map of selected components;
defining attributes for said selected components, based on a competency lens;
identifying collaborations for said selected components;
building a business component solution stack using said heat map, said attributes, and said collaborations;
developing quick hits and investment opportunities from said solution stack;
defining a roadmap of tasks for implementing said quick hits and investment opportunities; and
implementing said roadmap for said business.

2. The method of claim 1, wherein said activities are supported by appropriate processes, applications, infrastructure, and metrics.

3. The method of claim 1, wherein said components are individually scalable and extensible.

4. The method of claim 1, wherein said filtering is cost filtering wherein cost is allocated to all components based on FTE's and direct cost charges by support units.

5. The method of claim 1, wherein said filtering is revenue filtering wherein revenue allocation determines a percentage share of overall revenue based on organizational budget and relative comparison of said selected components.

6. The method of claim 1, wherein said competency lens . . .

7. The method of claim 1, wherein said collaborations comprise dynamic collaborations between said selected components.

8. The method of claim 1, wherein said collaborations comprise consolidator/server, processor, gatekeeper, controller, or analyzer collaborations.

9. The method of claim 1, wherein said solution stack is built using revenue levers and cost levers.

10. The method of claim 1, wherein said quick hits and investment opportunities are developed by categorizing each as either an application enhancement, new application, application reduction, or business process only.

11. A method of developing a business roadmap for a client, comprising the steps of:
building a map of client components of activities;
filtering said map of components to form a heat map of selected components;
defining attributes for said selected components, based on a client competency lens;
identifying collaborations for said selected components;
building a business component solution stack using said heat map, said attributes, and said collaborations;
developing quick hits and investment opportunities from said solution stack; and
defining a client business roadmap of tasks for implementing said quick hits and investment opportunities.

12. The method of claim 11, further comprising the step of implementing said client business roadmap for said client.

13. The method of claim 11, wherein said activities are supported by appropriate processes, applications, infrastructure, and metrics.

14. The method of claim 11, wherein said components are individually scalable and extensible.

15. The method of claim 11, wherein said filtering is cost filtering wherein cost is allocated to all components based on FTE's and direct cost charges by support units.

16. The method of claim 11, wherein said filtering is revenue filtering wherein revenue allocation determines a percentage share of overall revenue based on organizational budget and relative comparison of said selected components.

17. The method of claim 11, wherein said competency lens is an evaluation criteria to be applied to said heat map.

18. The method of claim 11, wherein said collaborations comprise dynamic collaborations between said selected components.

19. The method of claim 11, wherein said collaborations comprise consolidator/server, processor, gatekeeper, controller, or analyzer collaborations.

20. The method of claim 11, wherein said solution stack is built using revenue and cost levers.

21. The method of claim 11, wherein said quick hits and investment opportunities are developed by categorizing each as either an application enhancement, new application, application reduction, or business process only.

22. A program storage device readable by a machine, tangibly embodying a program of instructions executable by the machine to perform method steps for operating a business, said method steps comprising:
building a map of components of activities;
filtering said map of components to form a heat map of selected components;
defining attributes for said selected components, based on a competency lens;
identifying collaborations for said selected components;
building a business component solution stack using said heat map, said attributes, and said collaborations;
developing quick hits and investment opportunities from said solution stack;
defining a roadmap of tasks for implementing said quick hits and investment opportunities; and
implementing said roadmap for said business.

23. The method of claim 1, including deploying process software for operating a business, said deployment comprising;
building a map of components of activities;
filtering said map of components to form a heat map of selected components;
defining attributes for said selected components, based on a competency lens;
identifying collaborations for said selected components;
building a business component solution stack using said heat map, said attributes, and said collaborations;
developing quick hits and investment opportunities from said solution stack;
defining a roadmap of tasks for implementing said quick hits and investment opportunities; and
implementing said roadmap for said business.

24. The method of claim 1, including integrating process software for operating a business, said integration comprising:
building a map of components of activities;
filtering said map of components to form a heat map of selected components;
defining attributes for said selected components, based on a competency lens;
identifying collaborations for said selected components;
building a business component solution stack using said heat map, said attributes, and said collaborations;
developing quick hits and investment opportunities from said solution stack;
defining a roadmap of tasks for implementing said quick hits and investment opportunities; and
implementing said roadmap for said business.

25. The method of claim 1, including deploying, accessing, and executing process software for operating a business, said method further comprising:
building a map of components of activities;
filtering said map of components to form a heat map of selected components;
defining attributes for said selected components, based on competency lens;
identifying collaborations for said selected components;
building a business component solution stack using said heat map, said attributes, and said collaborations;
developing quick hits and investment opportunities from said solution stack;
defining a roadmap of tasks for implementing said quick hits and investment opportunities; and
implementing said roadmap for said business.
